(19) United States
(12) Patent Application Publication
(10) Pub. No.: US 2011/0299977 A1
(43) Pub. Date: Dec. 8, 2011

(54) PATCH RING SEGMENT FOR A TURBOMACHINE COMPRESSOR

(75) Inventors: John David Memmer, Simpsonville, SC (US); Jeffrey Craig Moree, Greer, SC (US)

(73) Assignee: General Electric Company, Schenectady, NY (US)

(21) Appl. No.: 12/793,191

(22) Filed: Jun. 3, 2010

(51) Int. Cl. F01D 11/08; B23P 6/00

(52) U.S. Cl. 415/173.4; 29/888.021

(57) ABSTRACT

A turbomachine includes a compressor provided with a casing having an inner surface defining a flow path. At least one blade is rotatable within the flow path. The at least one blade includes a tip portion that is spaced from the inner surface. At least one patch ring segment is mounted to the inner surface of the casing. The at least one patch ring segment includes a body having a first end that extends to a second end through a surface portion. A first wall member extends from the first end and a second wall member extends from the second end. The first and second wall members include in-turned sections that define a C-shaped cross-section of the at least one patch ring segment.

### BACKGROUND OF THE INVENTION

Exemplary embodiments relate to the art of turbomachines and, more particularly, to a patch ring segment for a turbomachine compressor.

Turbomachine compressors create a compressed airflow that is channeled along a flow path and delivered to both a combustor and turbine. The compressor includes a plurality of blades or buckets that rotate in close proximity to a casing to create the compressed airflow. Surface defects in the casing, resulting from manufacturing or service wear, will degrade compressor performance. In order to increase performance, defects in the casing must be repaired. Currently, patch ring repair segments are installed in the casing to repair casing voids, incorrect machining, or an operational failure that results in surface damage.

Current patch ring repair segment designs include an attachment flange having a “T”-shaped cross-section. The attachment flange engages with corresponding structure on the compressor casing. The particular design of the flange enables easy installation and removal of the patch ring repair segment. However, while being readily replaceable, thermal gradients developed during certain compressor operations cause edge portions of the patch ring repair segment to deflect into the flow path and contact one or more of the plurality of blades. As such, once a patch ring segment is installed, it becomes necessary to machine tip portions of the plurality of blades to provide any necessary clearance. The loss of the tip portions results in a reduced compressor flow and lower operational efficiency.

### BRIEF DESCRIPTION OF THE INVENTION

According to one aspect of the invention, a turbomachine includes a compressor provided with a casing having an inner surface defining a flow path, and at least one blade is rotatable within the flow path. The at least one blade includes a tip portion that is spaced from the inner surface. At least one patch ring segment is mounted to the inner surface of the casing. The at least one patch ring segment includes a body having a first end that extends to a second end through a surface portion. A first wall member extends from the first end and a second wall member extends from the second end. The first and second wall members include in-turned sections that define a C-shaped cross-section of the at least one patch ring segment.

According to another aspect of the invention, a turbomachine includes a turbomachine component provided with a casing having an inner surface defining a flow path, and at least one blade rotatable within the flow path. The at least one blade includes a tip portion that is spaced from the inner surface. At least one patch ring segment is mounted to the inner surface of the casing. The at least one patch ring segment includes a body having a first end that extends to a second end through a surface portion. A first wall member extends from the first end and a second wall member extends from the second end. The first and second wall members include in-turned sections that define a C-shaped cross-section of the at least one patch ring segment.

According to yet another aspect of the invention, a method of re-surfacing a flow path portion of a casing for a turbomachine component includes removing a portion of a surface of the flow path portion of the turbomachine component and exposing first and second flange elements that extend the casing into the flow path. The first and second flange elements define corresponding first and second grooves. A patch ring segment having first and second wall members is positioned adjacent to the first and second flange elements. The first and second wall members include corresponding first and second in-turned sections that define a C-shaped cross-section. The first and second in-turned sections are aligned with corresponding ones of the first and second grooves, and the patch ring segment is shifted along the casing to provide a renewed surface section in the flow path.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is cross-sectional view of a flow path portion of a turbomachine component including a patch ring segment in accordance with an exemplary embodiment;

FIG. 2 is a detail view of a casing portion of the turbomachine component of FIG. 1;

FIG. 3 is a detail view of the patch ring segment installed in the casing portion of the turbomachine component of FIG. 2; and

FIG. 4 is a perspective view of the casing portion of the turbomachine including a plurality of patch ring segments installed on an internal surface thereof.

The detailed description explains embodiments of the invention, together with advantages and features, by way of example with reference to the drawings.

### DETAILED DESCRIPTION OF THE INVENTION

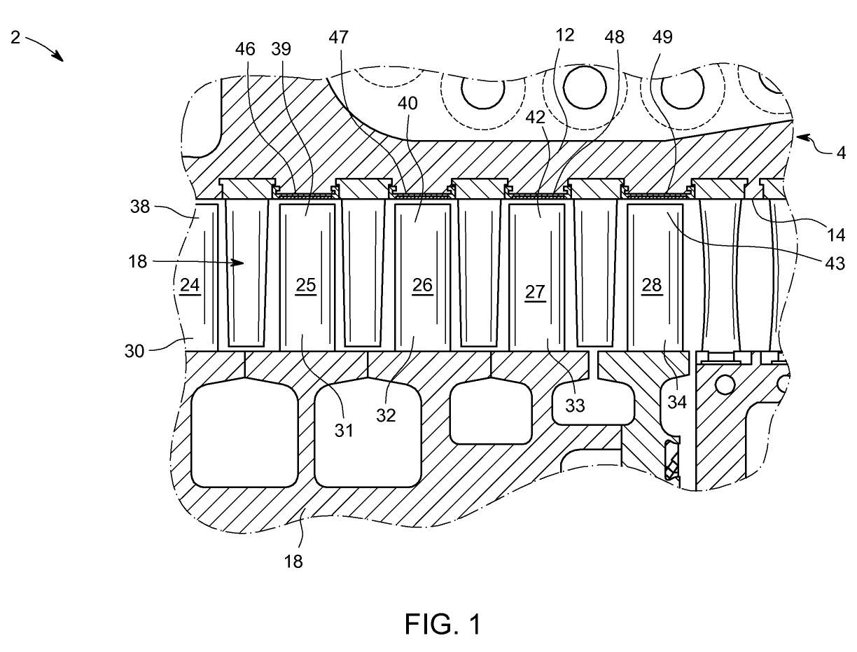

With reference to FIG. 1, a turbomachine in accordance with an exemplary embodiment is indicated generally at 2. Turbomachine 2 includes a turbomachine component which, in the exemplary embodiment shown, takes the form of a compressor 4. Compressor 4 includes a casing 12 having an inner surface 14 that defines a flow path 18. Compressor 4 is also shown to include a plurality of rotor blades 24-28 that are rotatably mounted within casing 12. Rotor blades 24-28 include corresponding base portions 30-34 and tip portions 38-43. Tip portions 38-43 are spaced from inner surface 14 of casing 12. In the exemplary embodiment shown, compressor 4 includes a plurality of patch ring segments 46-49 that are installed to casing 12 to renew portions of inner surface 14 adjacent tip portions 38-43 respectively.

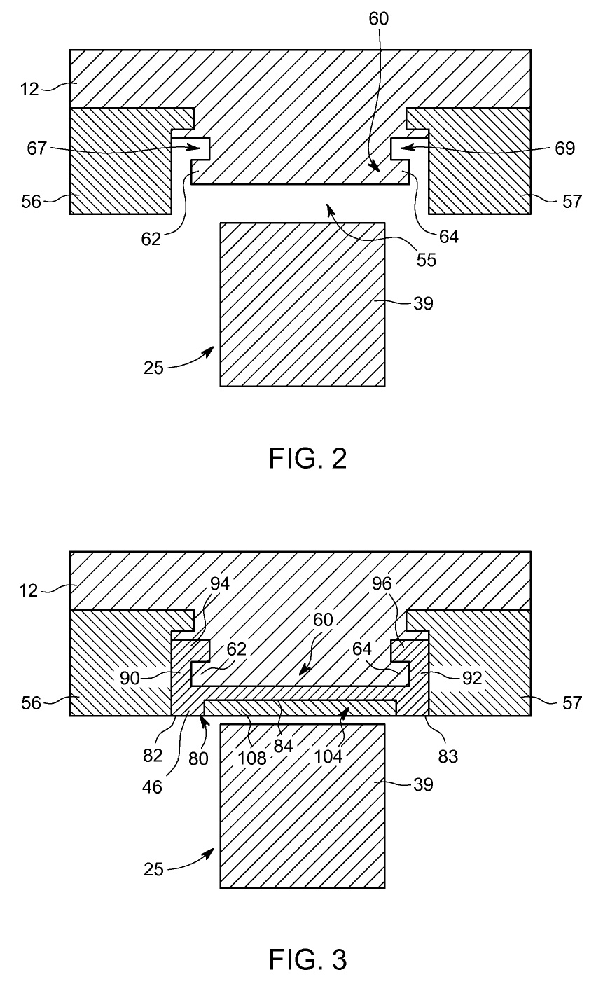

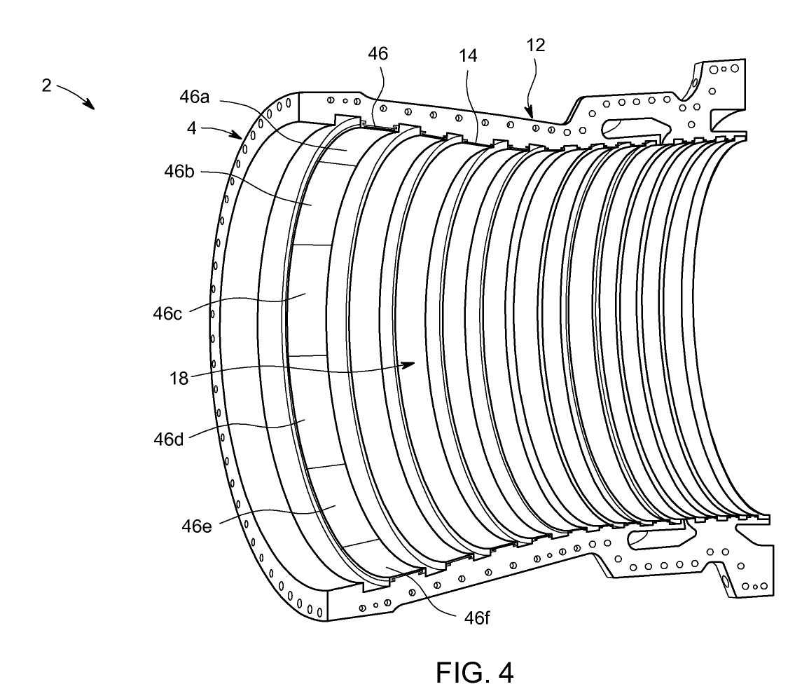

As best shown in FIGS. 2 and 3, casing 12 includes a channel 55 arranged between adjacent stator base members 56 and 57. Channel 55 is configured to receive, for example, one or more patch ring segments 46 in a manner that will become more fully evident below. Channel 55 includes a mounting element 60 having a first flange element 62 and a second flange element 64. First flange element 62 defines a first groove 67 within channel 55 and second flange element 64 defines a second, opposing groove 69 within channel 55. As will be detailed more fully below, grooves 67 and 69 provide structure for slidingly receiving patch ring segment 46.

Reference will now follow to FIG. 3 in describing patch ring segment 46 with an understanding that the remaining patch ring segments 47-49 include similar structure. Patch ring segment 46 includes a body 80 having a first end 82 that extends to a second end 83 through a surface portion 84. First end 82 includes a first wall member 90 and second end 83 includes a second wall member 92. First and second wall members 90 and 92 include corresponding first and second in-turned sections 94 and 96 that define a slot (not separately labeled) in body 80. With this arrangement, patch ring segment 80 includes a C-shaped cross-section. In addition, patch ring segment 46 includes a recess 104 that is provided with an abradable material 108. Abradable material 108 is formed from a material that is considerably softer than tip portion 39 of rotor blade 25. In accordance with one aspect of the exemplary embodiment, abradable material 108 is formed from nickel chrome aluminum (NiCrAl), aluminum oxide (Al₂O₃), or combinations thereof. Of course, other materials that are softer than rotor blades 24-28 can also be employed.

In accordance with an exemplary embodiment, first and second in-turned sections 94 and 96 are configured and disposed to be received within grooves 67 and 69 respectively. More specifically, in the event that there exist surface disturbances on casing 12, portions of inner surface 14 are removed to expose channel 55. Once exposed, patch ring segment 46 is aligned with mounting element 60. At this point, first and second in-turned sections 94 and 96 are inserted into grooves 67 and 69 and patch ring segment 46 is shifted into place. After installing patch ring segment 46, additional patch ring segments 46b-46f (FIG. 4) are installed along with even more patch ring segments (not shown) to form a circumferential patch ring (not separately labeled) within casing 12. Once installed, rotor blades 24-28 are spun and, if any interference zones exist, tip portion 39 will wear away a portion of abradable material 108 on one or more of patch ring segments 46 to establish a desired clearance.

At this point it should be understood that the exemplary embodiments provide a system for re-surfacing an inner surface of a turbomachine component. The interaction between the first and second flange elements and the first and second in-turned sections ensures that the edge portions of the patch ring segment do not deflect into the flow path and contact one or more of the rotor blades. In addition, it should be understood that while shown and described in connection with a compressor, the patch ring segments in accordance with the exemplary embodiments can also be employed in other turbomachine components such as turbines.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A turbomachine comprising:
a compressor including a casing having an inner surface defining a flow path, and at least one blade rotatable within the flow path, the at least one blade having a tip portion that is spaced from the inner surface; and
at least one patch ring segment mounted to the inner surface of the casing, the at least one patch ring segment including a body having a first end that extends to a second end through a surface portion, a first wall member extends from the first end and a second wall member extends from the second end, the first and second wall members including in-turned sections that define a C-shaped cross-section of the at least one patch ring segment.

2. The turbomachine according to claim 1, wherein the at least one patch ring segment includes a recess formed in the surface portion, the recess defining a clearance zone between the tip portion and the casing.

3. The turbomachine according to claim 2, further comprising: an abradable material positioned within the recess formed in the surface portion.

4. The turbomachine according to claim 3, wherein the abradable material comprises nickel chrome aluminum.

5. The turbomachine according to claim 3, wherein the abradable material comprises aluminum oxide.

6. The turbomachine according to claim 3, wherein the abradable material comprises nickel chrome aluminum and aluminum oxide.

7. The turbomachine according to claim 1, further comprising: first and second flange elements formed in the casing, the first and second flange elements being configured and disposed to receive respective ones of the first and second wall members to detachably secure the at least one patch ring segment to the compressor.

8. The turbomachine according to claim 1, wherein the at least one patch ring segment includes a plurality of patch ring segments that extend about the inner surface of the casing to form a patch ring.

9. A turbomachine comprising:
a turbomachine component including a casing having an inner surface defining a flow path, and at least one blade rotatable within the flow path, the at least one blade having a tip portion that is spaced from the inner surface; and
at least one patch ring segment mounted to the inner surface of the casing, the at least one patch ring segment including a body having a first end that extends to a second end through a surface portion, a first wall member extends from the first end and a second wall member extends from the second end, the first and second wall members including in-turned sections that define a C-shaped cross-section of the at least one patch ring segment.

10. The turbomachine according to claim 9, wherein the at least one patch ring segment includes a recess formed in the surface portion, the recess establishing a clearance zone between the tip portion and the casing.

11. The turbomachine according to claim 10, further comprising: an abradable material positioned within the recess formed in the surface portion.

12. The turbomachine according to claim 11, wherein the abradable material comprises nickel chrome aluminum.

13. The turbomachine according to claim 11, wherein the abradable material comprises aluminum oxide.

14. The turbomachine according to claim 11, wherein the abradable material comprises nickel chrome aluminum and aluminum oxide.

15. The turbomachine according to claim 8, further comprising: first and second flange elements formed in the casing, the first and second flange elements being configured and disposed to receive respective ones of the first and second wall members to detachably secure the at least one patch ring segment to the turbomachine component.

16. A method of re-surfacing a flow path portion of a casing for a turbomachine component, the method comprising:
removing a portion of a surface of the flow path portion of the turbomachine component;
exposing first and second flange elements extending from the casing into the flow path, the first and second flange elements defining corresponding first and second grooves;
positioning a patch ring segment having first and second wall members adjacent to the first and second flange elements, the first and second wall members including corresponding first and second in-turned sections that define a C-shaped cross-section;
aligning the first and second in-turned sections with corresponding ones of the first and second grooves; and
shifting the patch ring segment along the casing to provided a renewed surface section in the flow path.

17. The method of claim 16, rotating blades having tip portions within the turbomachine component, the tip portions impacting an abradable surface provided on the patch ring segment to establish a desired clearance.

18. The method of claim 16, further comprising: mounting a plurality of patch ring segments to the first and second wall members.

19. The method of claim 18, further comprising: aligning the plurality of patch ring segments to form a patch ring extending about the casing.

20. The method of claim 16, further comprising:
rotating a turbomachine component relative to the patch ring segment; and
abrading a portion of the patch ring segment to establish a desired clearance.
